(19) United States
(12) Patent Application Publication
(10) Pub. No.: US 2018/0372571 A1
(43) Pub. Date: Dec. 27, 2018

(54) PRESSURE SENSOR AND METHOD FOR OPERATING A PRESSURE SENSOR

(71) Applicant: Endress+Hauser SE+Co. KG, Maulburg (DE)

(72) Inventors: Max Jehle, Wehr (DE); Marc Andreas Schlachter, Wehr (DE); Davide Parrotto, Weil am Rhein (DE)

(21) Appl. No.: 16/061,598

(22) PCT Filed: Nov. 15, 2016
(86) PCT No.: PCT/EP2016/077716

§ 371 Date: Jun. 12, 2018

(30) Foreign Application Priority Data
Dec. 15, 2015 (DE) 10 2015 121 859.3

(51) Int. Cl. G01L 9/00; G01L 19/14

(52) U.S. Cl. CPC G01L 9/002; G01L 19/14; G01L 9/0042

(57) ABSTRACT

Pressure sensor comprising a housing, a pressure sensor element arranged in the housing, a lighting means arranged in the housing, and a control/evaluation unit, wherein the pressure sensor element has a semiconductor material and a measuring membrane, wherein a first pressure is supplied to a first side of the measuring membrane and a second pressure to a second side of the measuring membrane, and the measuring membrane experiences a pressure-dependent deflection, wherein the lighting means provides an optical excitation of the pressure sensor element and the control/evaluation unit, based on a change of the electrical signal caused by the optical excitation, ascertains a static pressure value present in the first and/or second pressure and performs a correcting, or compensating, of the pressure measurement variable with the assistance of the static pressure value.

The invention relates to a pressure sensor for determining a pressure measurement variable as well as to a method for operating such a pressure sensor.

Pressure sensors serve for registering pressures and are widely used in industrial measurements technology, for example, for fill level measurement or for flow measurement. In such case, depending on area of application, different characteristics of pressure sensors are used. Thus, a pressure sensor can be embodied, for example, as an absolute pressure sensor, a relative pressure sensor or even a pressure difference sensor. Basically, however, all pressure sensors are equally constructed and comprise typically a housing, in which a pressure sensor element is arranged. In pressure measuring technology, semiconductor pressure sensor elements, for example, pressure sensor elements based on silicon, are widely applied. Semiconductor pressure sensor elements comprise, in such case, a measuring membrane, in whose edge region typically four resistance elements are integrated. The measuring membrane is supplied on its first side with a first pressure and on its second side with a second pressure, and the two pressures subtract, the smaller from the larger, to bring about a net deflection of the measuring membrane. The pressure-dependent deflection of the measuring membrane is registered via the integrated resistance elements and evaluated, so that a pressure measurement variable can be output. As a function of whether it is a relative pressure sensor, an absolute pressure sensor or a pressure difference sensor, the measuring membrane is supplied with the appropriate two pressures.

In the case, in which the pressure sensor is embodied as an absolute pressure sensor, one of the two sides of the measuring membrane is exposed to a vacuum and the other side of the measuring membrane is fed a media pressure to be measured. The absolute pressure sensor measures, thus, the absolute pressure, thus the media pressure to be measured relative to vacuum as reference pressure.

In the case, in which the pressure sensor is embodied as a relative pressure sensor, one of the two sides of the measuring membrane is exposed to atmospheric air pressure as reference pressure and the other side of the measuring membrane is fed a media pressure to be measured. The relative pressure sensor measures, thus, a relative pressure, thus the media pressure to be measured relative to the atmospheric air pressure.

In the case, in which the pressure sensor is embodied as a pressure difference sensor, one of the two sides of the measuring membrane is fed a first media pressure to be measured and the other side of the measuring membrane is fed a second media pressure to be measured. The pressure difference sensor measures, thus, a pressure difference, thus the difference between the two media pressures.

All pressure sensors have in common that the ascertained pressure measurement variable can contain measurement error. These measurement errors are given in the specifications of the pressure sensors via a tolerance range, within which the ascertained pressure measurement variable should appear with a defined probability. Such measurement error can arise due to changes of a static pressure present in the media pressure.

It is, consequently, an object of the present invention is to provide an opportunity for lessening such measurement error.

The object is achieved by a pressure sensor and by a method for operating such a pressure sensor.

As regards the pressure sensor, the object is achieved by a pressure sensor for determining a pressure measurement variable, comprising at least one housing, a pressure sensor element arranged in the housing, a lighting means likewise arranged in the housing, as well as a control/evaluation unit, wherein the pressure sensor element has a semiconductor material and a measuring membrane, wherein a first pressure is supplied to a first side of the measuring membrane and a second pressure to a second side of the measuring membrane, and the measuring membrane experiences a pressure-dependent deflection, wherein the measuring membrane has at least one integrated resistance element and the control/evaluation unit ascertains with the assistance of the integrated resistance element an electrical signal for pressure measurement variable determination, wherein the lighting means provides an optical excitation of the pressure sensor element and the control/evaluation unit, based on a change of the electrical signal caused by the optical excitation, ascertains a static pressure value present in the first and/or second pressure and performs a correcting, or compensating, of the pressure measurement variable with the assistance of the static pressure value.

According to the invention, the effect referred to as photoconduction is utilized to obtain information concerning a static pressure. The static pressure is present in a media pressure acting at least on one of the two sides of the measuring membrane.

In general, photoconduction is an effect associated with the inner photoelectric effect, in the case of which the electrical conductivity of semiconductor materials increases due to the forming of unbound electron hole pairs in the face of irradiation. Due to the irradiation of the pressure sensor element, which includes at least one semiconductor material and a measuring membrane, an electrical signal, for example, a bridge voltage signal, is changed. Based on this change, the static pressure value can be ascertained. With the help of this static pressure value, a pressure measurement variable ascertained by the pressure sensor is corrected, or compensated.

An advantageous embodiment of the pressure sensor of the invention provides that the optical excitation includes a plurality of individual optical pulses.

Another advantageous embodiment of the pressure sensor of the invention provides that the measuring membrane has additional integrated resistance elements and a lighting means is provided for each additional resistance element.

Another advantageous embodiment of the pressure sensor of the invention provides that the lighting means is a light-emitting diode.

Another advantageous embodiment of the pressure sensor of the invention provides that the optical excitation occurs cyclically and wherein during two cycles the control/evaluation unit uses the last ascertained static pressure value for correcting, or compensating.

As regards the method, the object is achieved by a method for operating a pressure sensor, which is embodied especially according to one of the preceding embodiments, wherein the pressure sensor includes a pressure sensor element, which has a semiconductor material and a measuring membrane, which is supplied a first pressure on a first side and a second pressure on a second side, wherein the method comprises steps as follows:

optically exciting the pressure sensor element;

registering a change of an electrical signal caused by the optical excitation;

ascertaining a static pressure value based on the change of the electrical signal;

correcting, or compensating, a pressure sensor ascertained, pressure measurement variable based on the static pressure value.

An advantageous form of embodiment of the method of the invention provides that a plurality of individual optical pulses are used for the optical excitation and, for registering the change of the electrical signal, a plurality of individual electrical signal values are registered. Especially, this form of embodiment provides that the change of the electrical signal is ascertained by averaging the registered plurality of individual electrical signal values.

Another advantageous form of embodiment of the method of the invention provides that the optical excitation is performed cyclically during measurement operation.

A last advantageous form of embodiment of the method of the invention provides that the correcting, or compensating, is performed via a look-up table and/or a mathematical equation.

The invention will now be explained in greater detail based on the appended drawing, the figures of which show as follows:

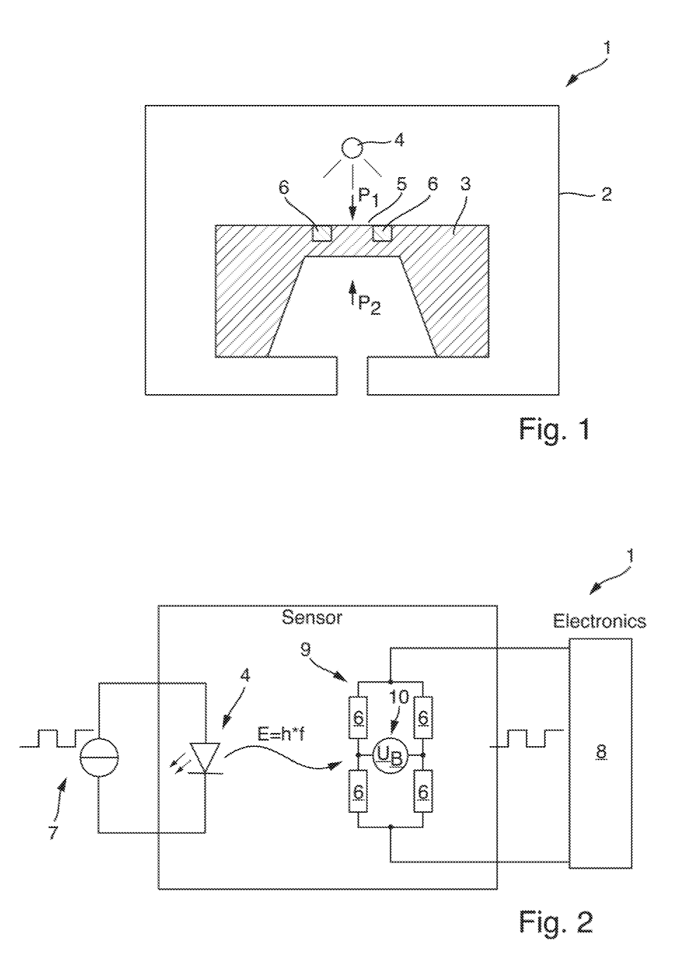

FIG. 1 a schematic representation of the pressure sensor of the invention,

FIG. 2 a schematic block diagram of the pressure sensor of the invention,

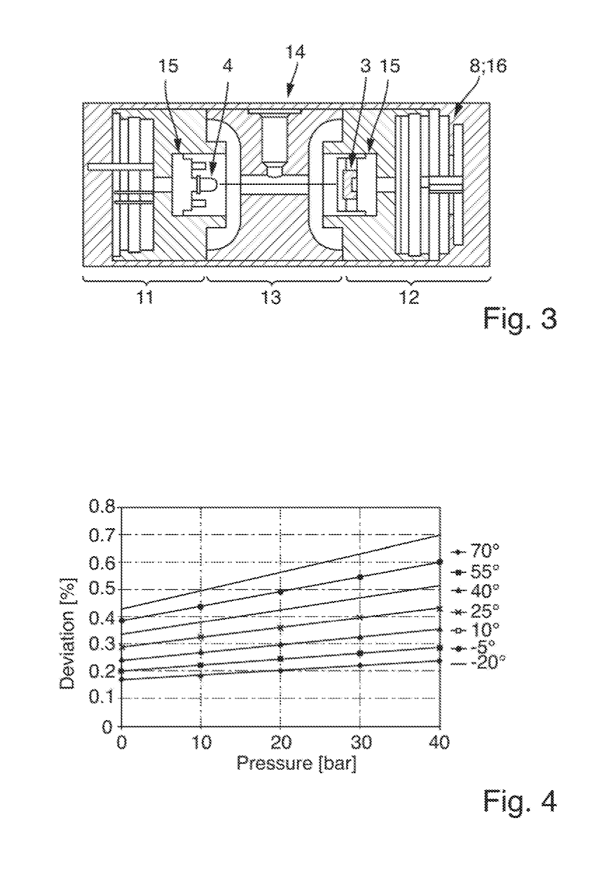

FIG. 3 an experimental setup, which served for investigating the effect,

FIG. 4 a first measurement curve, or measurement curves, experimentally ascertained from the experimental setup,

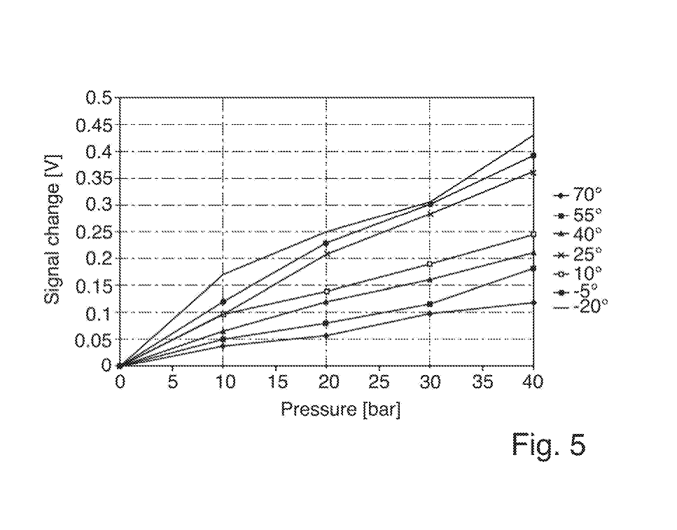

FIG. 5 a second measurement curve, or measurement curves, experimentally ascertained from the experimental setup,

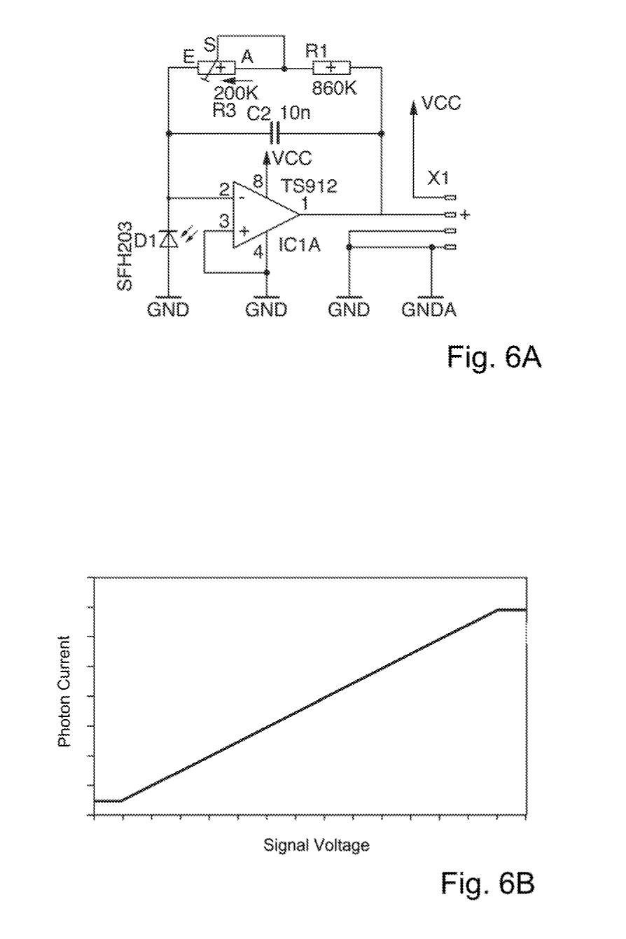

FIG. 6(a) an amplifier circuit of a photodiode,

FIG. 6(b) an output signal of the amplifier circuit,

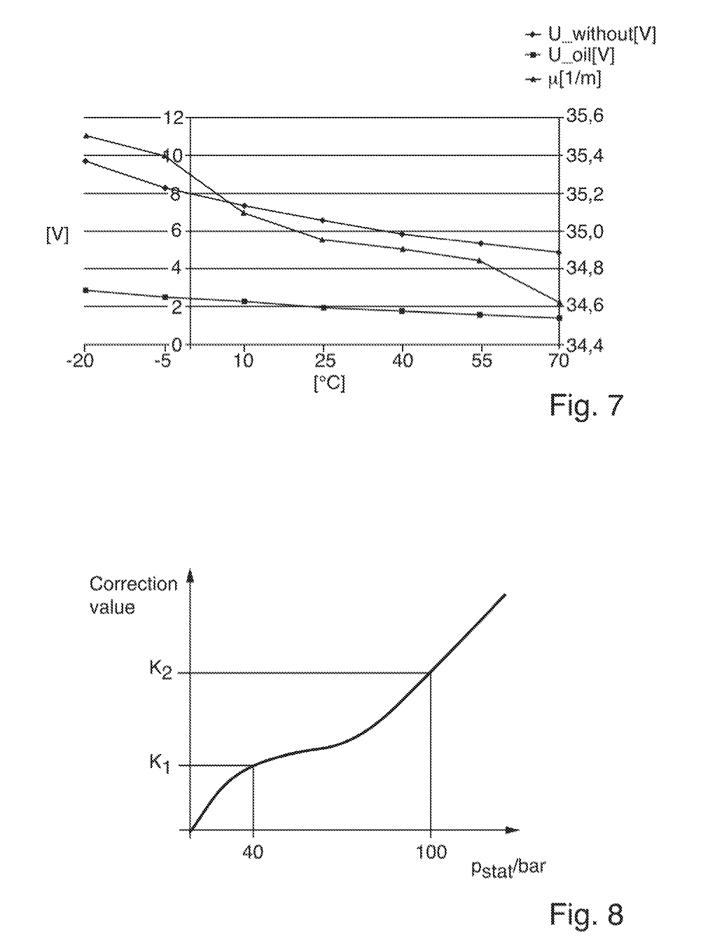

FIG. 7 a third measurement curve, or measurement curves, experimentally ascertained from the experimental setup,

FIG. 8 by way of example, a correction function, which is applicable for correcting, or compensating, the pressure measurement variable of a pressure sensor, and

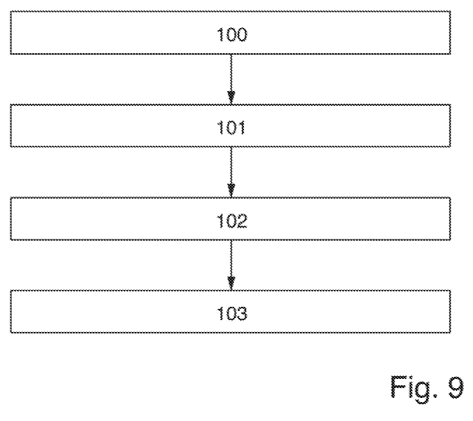

FIG. 9 a schematic representation of the method steps of the method of the invention.

FIG. 1 shows a schematic representation of the pressure sensor of the invention 1. This includes a housing 2, a pressure sensor element 3 arranged in the housing 2 and a lighting means 4 likewise arranged in the housing.

The pressure sensor element 3 introduced into the housing 2 includes a semiconductor material, preferably silicon. Formed in the pressure sensor element 3, for example, by an etching process, is a measuring membrane 5. For determining a pressure measurement variable, for example, when the pressure sensor 1 is embodied as a relative pressure sensor, the measuring membrane 5 is fed a first pressure p₁ on a first side, for example, an atmospheric pressure, and a second pressure p₂ on a second side, for example, a media pressure to be measured, which contains a static pressure.

For registering a pressure dependent deflection produced by applying the pressures p₁ and p₂, the measuring membrane includes, in turn, four resistance elements 6, which are produced, for example, by doping the semiconductor material. The resistance elements 6 integrated in this way into the measuring membrane 5 are typically arranged in the edge region of the measuring membrane 5, in order to register the pressure-dependent deflection of the measuring membrane 5 in the form of a resistance change. Based on the resistance changes of the resistance elements 6, the pressure sensor 1 can ascertain, and output, a pressure measurement variable.

FIG. 1 shows, thus, a relative pressure sensor. The invention is, however, also applicable to the same extent to an absolute pressure- or pressure difference sensor.

FIG. 2 shows a schematic block diagram of the pressure sensor 1 of the invention, which includes, besides the lighting means 4 with corresponding lighting means control unit 7 and the resistance elements 6, supplementally a control/evaluation unit 8. The resistance elements 6 are interconnected to form a Wheatstone bridge 9 and the control/evaluation unit 8 serves typically for registering one of the resistance values representing electrical signal 10, for example, the bridge voltage signal U_{B}. Based on the registered electrical signal 10, in the illustrated case the bridge voltage U_{B}, the control/evaluation unit 8 ascertains a pressure measurement variable.

FIG. 3 shows an experimental setup, which served for investigating the effect. The experimental setup includes a first assembly 11 and a second assembly 12, which are connected together via a hydraulic chamber interconnect 13. The first assembly 11 includes a light-emitting diode 4 (LED) on a Transistor Outline support of the type 8 (TO-8) and the second assembly a pressure sensor element, which is likewise located on a TO-8 support. The hydraulic chamber interconnect 13 includes a fill nozzle 14 for filling the hydraulic chamber interconnect 13 with a pressure transfer liquid, e.g. a silicone oil.

The pressure sensor element is electrically connected with a sensor electronics, which includes especially a control/evaluation unit. Via the sensor electronics, the electrical signal, which results from the resistance change of the resistance elements 6 of the Wheatstone bridge 9, is converted into a pressure measurement variable.

FIG. 4 shows a number of first measurement curves experimentally ascertained based on the above described experimental setup. For this, both the LED as well as also the pressure sensor element were supplied via the hydraulic chamber interconnect simultaneously with the static pressure. Additionally, the pressure sensor element was optically excited by the LED. To be exact, a relative pressure sensor was operated at different static pressures (p=0-40 bar) and different temperatures (T=−20° C.-70° C.). The optical excitation occurred using a number of individual optical pulses at the corresponding pressures and temperatures. Registered was the change, or deviation, of the electrical signal via an averaging of the registered number of individual signal values, wherein the change, or deviation, is the difference between the electrical signal with optical excitation and the electrical signal without optical excitation.

As is evident from FIG. 4, the pressure sensor element showed both a pressure-dependent as well as also a temperature dependent change of the electrical signal in the form of the bridge voltage, so that an ascertaining of a static pressure value for correcting, or compensating, the pressure measurement variable by exploitation of the photoelectric effect appears, in principle, to be possible.

FIG. 5 shows a number of second measurement curves experimentally ascertained based on the above described experimental setup. In this case in the described experimental setup, the pressure sensor element was replaced by a photodiode as receiver and both the LED as well as also the photodiode were exposed to the static pressure, wherein the hydraulic chamber interconnect was not filled with the pressure transfer liquid. The linearity deviations are attributed to the fact that the effect superimposed both on the photodiode as well as also on the LED. For evaluation of the photodiode, the amplifier circuit shown in FIG. 6(a) was used, which maps a photon current from 0 to 15 μA to an output signal from 0 to 15 V. Such an output signal is shown in FIG. 6(b) by way of example.

FIG. 7 shows a number of third measurement curves experimentally ascertained based on the experimental setup. In this case in the described experimental setup, again, the pressure sensor element was replaced by a photodiode as receiver and both the LED as well as also the photodiode were exposed to the static pressure, wherein the hydraulic chamber interconnect was once filled with the pressure transfer liquid and once unfilled. Evident from FIG. 7 is that a temperature dependent absorption coefficient of the pressure transfer means results, which is likewise to be taken into consideration in the correcting, or compensating.

Evident from the first to third measurement curves is that the photoelectric effect can be used for estimating the static pressure in a pressure sensor, so that with the assistance of a mathematical model the measurement error of a pressure sensor can be reduced. For this, for example, a correction function, such as shown in FIG. 8 by way of example, can be used.

For the correcting, or compensating, the control/evaluation unit 8 is designed to execute the method of the invention shown schematically in FIG. 9 and described below according to method steps as follows:
optically exciting the pressure sensor element 100 by at least one lighting means, for example, in the form of a light-emitting diode. The optical excitation can occur, in such case, by means of a single, or selectively via a plurality of, lighting means, preferably one lighting means per resistance element. Proved as advantageous is when the lighting means is pulsed, i.e. the optical excitation occurs by a plurality of individual optical pulses, which directly follow one another. Furthermore, it has proved as advantageous that the optical excitation is performed cyclically during measurement operation.
registering a change of the electrical signal 101 caused by the optical excitation, wherein in the case, in which each resistance element 6 has its own lighting means 4 and, thus, a selective optical excitation of the resistance elements 6 occurs, preferably, in each case, an electrical signal 10 of each of the resistance elements 6 is registered.
In the case, which the optical excitation is produced using a number of individual pulses, it is advantageous to determine the change of the electrical signal by averaging the registered individual signal values.
ascertaining a static pressure value based on the change of the electrical signal (102).
based on the static pressure value (103), correcting, or compensating, a pressure measurement variable ascertained by the pressure sensor.

### LIST OF REFERENCE CHARACTERS

1 pressure sensor

2 housing

3 pressure sensor element

4 lighting means

5 measuring membrane

6 resistance element

7 lighting means control unit

8 control/evaluation unit

9 Wheatstone bridge

10 electrical signal

11 first assembly

12 second assembly

13 hydraulic chamber interconnect

14 fill nozzle

15 TO-8 housing

16 sensor electronics

17 photodiode

p₁ first pressure

p₂ second pressure

U_{B} bridge voltage

1-10. (canceled)

11. A pressure sensor for determining a pressure measurement variable, comprising:
a housing;
a pressure sensor element arranged in the housing, the pressure sensor element including a semiconductor material and a measuring membrane having at least one integrated resistance element, wherein the housing is configured to enable a first pressure to be applied to a first side of the measuring membrane and a second pressure to be applied to a second side of the measuring membrane, such that the measuring membrane experiences a pressure-dependent deflection;
a light source arranged in the housing and adapted to provide an optical excitation of the pressure sensor element; and
a control/evaluation unit configured to ascertain, using the integrated resistance element, an electrical signal for determining a pressure measurement variable, to determine a static pressure value from the first pressure and/or second pressure based on a change of the electrical signal caused by the optical excitation, and to perform a correcting, or compensating, of the pressure measurement variable using the static pressure value.

12. The pressure sensor of claim 11, wherein the optical excitation includes a plurality of individual optical pulses.

13. The pressure sensor of claim 11, wherein the measuring membrane includes additional integrated resistance elements and an additional light source is provided for each additional resistance element.

14. The pressure sensor of claim 11, wherein the light source is a light-emitting diode.

15. The pressure sensor of claim 11, wherein the optical excitation occurs cyclically, wherein during two cycles the control/evaluation unit uses the last determined static pressure value for the correcting or compensating.

16. A method for operating a pressure sensor, the method comprising:
optically exciting a pressure sensor element of a pressure sensor using a light source, the pressure sensor further including:
a housing, wherein the light source and the pressure sensor element are arranged in the housing, wherein the pressure sensor element includes a semiconductor material and a measuring membrane having at least one integrated resistance element, and wherein the housing is configured to enable a first pressure to be applied to a first side of the measuring membrane and a second pressure to be applied to a second side of the measuring membrane, such that the measuring membrane experiences a pressure-dependent deflection; and
a control/evaluation unit configured to execute the method;
determining a pressure measurement variable using the pressure sensor;
using the control/evaluation unit, registering a change of an electrical signal from the at least one integrated resistance element caused by optically exciting the pressure sensor element;
determining a static pressure value based on the change of the electrical signal using the control/evaluation unit; and
correcting or compensating the pressure measurement variable of the pressure sensor based on the static pressure value using the control/evaluation unit.

17. The method of claim 16, wherein a plurality of individual optical pulses are used to optically excite the pressure sensor element and, for registering the change of the electrical signal, a plurality of individual electrical signal values are registered.

18. The method of claim 17, wherein the change of the electrical signal is determined by averaging the registered plurality of individual electrical signal values.

19. The method of claim 16, wherein the pressure sensor element is optically excited cyclically during measurement operation.

20. The method of claim 16, wherein the correcting, or compensating, is performed via a look-up table and/or a mathematical equation.
